(19) United States
(12) Patent Application Publication
(10) Pub. No.: US 2021/0157512 A1
(43) Pub. Date: May 27, 2021

(54) FLEXIBLE CONFIGURATION OF STORAGE DEVICE WITH TRANSLATION LANGUAGE SET

(71) Applicant: Intel Corporation, Santa Clara, CA (US)

(72) Inventors: Joseph Tarango, Longmont, CO (US); Jim Baca, Corrales, NM (US); Kristin Jacque, Longmont, CO (US); Andres Hernandez, Denver, CO (US)

(73) Assignee: Intel Corporation, Santa Clara, CA (US)

(21) Appl. No.: 17/165,698

(22) Filed: Feb. 2, 2021

(51) Int. Cl. G06F 3/06

(52) U.S. Cl. CPC G06F 3/0655; G06F 3/0604; G06F 3/0679

(57) ABSTRACT

An embodiment of an electronic apparatus may include one or more substrates, a controller coupled to the one or more substrates, the controller including logic to control access to a NAND-based storage media, communicate with a host device and a neighbor storage device through a translation language set, convert the translation language set to native commands, and execute the native commands. Other embodiments are disclosed and claimed.

### BACKGROUND

A datacenter may include a wide variety of computing devices such as processor device, storage devices, and network devices. Such devices may be housed in racks as blades that can be inserted and removed for repair, upgrade, and replacement as needed to maintain or expand the capabilities of the datacenter. Over time, the number of devices in the datacenter and differences among the devices creates a heterogenous computing environment that may be challenging to configure in a manner that makes the best and most efficient utilization of the resources of the datacenter.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an example of an electronic storage system according to an embodiment;

FIG. 2 is a block diagram of an example of an electronic apparatus according to an embodiment;

FIGS. 3A to 3C are flowcharts of an example of a method of controlling storage according to an embodiment;

FIG. 4 is a flowchart of an example of a process flow according to an embodiment;

FIG. 5A is a block diagram of an example of a computing environment according to an embodiment;

FIG. 5B is a block diagram of an example of a resource allocation system according to an embodiment for the computing environment from FIG. 5A;

FIG. 6 is a block diagram of another example of a storage system according to an embodiment;

FIG. 7 is a block diagram of another example of a storage system according to an embodiment;

FIG. 8 is a flowchart of another example of a process flow according to an embodiment;

FIG. 9 is a block diagram of an example of a computing system according to an embodiment;

FIG. 10 is a block diagram of another example of a computing system according to an embodiment; and

FIG. 11 is a block diagram of an example of a solid-state drive (SSD) device according to an embodiment.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Various embodiments described herein may include a memory component and/or an interface to a memory component. Such memory components may include volatile and/or nonvolatile (NV) memory. Volatile memory may be a storage medium that requires power to maintain the state of data stored by the medium. Non-limiting examples of volatile memory may include various types of RAM, such as dynamic RAM (DRAM) or static RAM (SRAM). One particular type of DRAM that may be used in a memory module is synchronous dynamic RAM (SDRAM). NV memory (NVM) may be a storage medium that does not require power to maintain the state of data stored by the medium. In one embodiment, the memory device may include a block addressable memory device, such as those based on NAND technologies. In one embodiment, the memory device may be or may include memory devices that use multi-threshold level NAND flash memory, or other memory. The memory device may refer to the die itself and/or to a packaged memory product.

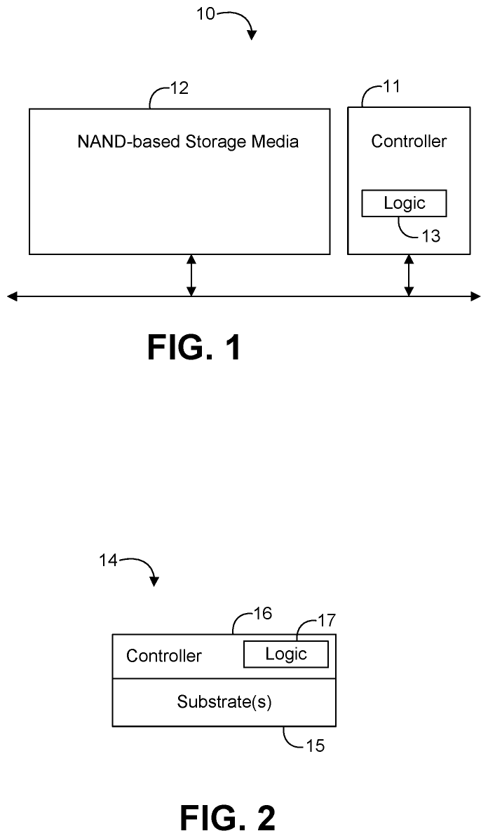

With reference to FIG. 1, an embodiment of an electronic storage system 10 may include NAND-based storage media 12, and a controller 11 communicatively coupled to the NAND-based storage media 12. The controller 11 may include logic 13 to communicate with a host device and a neighbor storage device through a translation language set, convert the translation language set to native commands, and execute the native commands. For example, the logic 13 may be configured to notify and receive capability notifications to the host device and the neighbor storage device with the translation language set. In some embodiments, the logic 13 may be further configured to re-configure one or more of the controller 11 and the NAND-based storage media 12 in response to a translation language set communication from one or more of the host device and the neighbor storage device. For example, the logic 13 may also be configured to lock a configuration of the controller 11 and the NAND-based storage media 12 in response to a translation language set communication from one or more of the host device and the neighbor storage device.

In some embodiments, the logic 13 may be further configured to asynchronously communicate with the host device and the neighbor storage device. For example, the logic 13 may be configured to utilize a shared register space to asynchronously communicate with the host device and the neighbor storage device. In some embodiments, the logic 13 may be further configured to offload computation from one or more of the host device and the neighbor storage device in response to a translation language set communication (e.g., or from the controller 11 to the host device or the neighbor storage device), and/or to share accelerator code among the controller 11 and one or more of the host device and the neighbor storage device with the translation language set. In any of the embodiments herein, the controller 11 and the NAND-based storage media 12 may be incorporated in a solid-state drive (SSD).

Embodiments of each of the above controller 11, NAND-based storage media 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the controller 11 may include a general purpose controller, a special purpose controller, a memory controller, a storage controller, a micro-controller, a general purpose processor, a special purpose processor, a central processor unit (CPU), an execution unit, etc. In some embodiments, the NAND-based storage media 12, the logic 13, and/or other system memory may be located in, or co-located with, various components, including the controller 11 (e.g., on a same die).

Alternatively, or additionally, all or portions of these components may be implemented in one or more modules as a set of logic instructions stored in a machine- or computer-readable storage medium such as RAM, ROM, programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the NAND-based storage media 12, other NAND-based storage media, or other system memory may store a set of instructions which when executed by the controller 11 cause the system 10 to implement one or more components, features, or aspects of the system 10 (e.g., the logic 13, communicating with the host device and the neighbor storage device through the translation language set, converting the translation language set to native commands, executing the native commands, etc.).

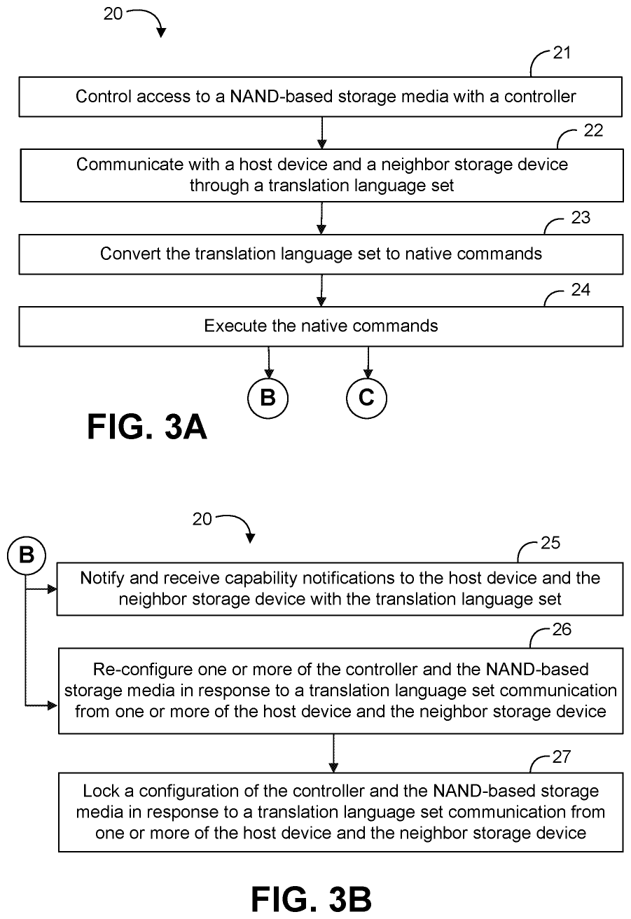

Turning now to FIG. 2, an embodiment of an electronic apparatus 14 may include one or more substrates 15, and a controller 16 coupled to the one or more substrates 15. The controller 16 may include logic 17 to control access to a NAND-based storage media, communicate with a host device and a neighbor storage device through a translation language set, convert the translation language set to native commands, and execute the native commands. For example, the logic 17 may be configured to notify and receive capability notifications to the host device and the neighbor storage device with the translation language set. In some embodiments, the logic 17 may be further configured to re-configure one or more of the controller and the NAND-based storage media in response to a translation language set communication from one or more of the host device and the neighbor storage device. For example, the logic 17 may also be configured to lock a configuration of the controller and the NAND-based storage media in response to a translation language set communication from one or more of the host device and the neighbor storage device.

In some embodiments, the logic 17 may be further configured to asynchronously communicate with the host device and the neighbor storage device. For example, the logic 17 may be configured to utilize a shared register space to asynchronously communicate with the host device and the neighbor storage device. In some embodiments, the logic 17 may be further configured to offload computation from one or more of the host device and the neighbor storage device in response to a translation language set communication (e.g., or from the controller to the host device or the neighbor storage device), and/or to share accelerator code among the controller and one or more of the host device and the neighbor storage device with the translation language set. In any of the embodiments herein, the controller and the NAND-based storage media may be incorporated in a SSD.

Embodiments of the logic 17 may be implemented in a system, apparatus, computer, device, etc., for example, such as those described herein. More particularly, hardware implementations of the logic 17 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the logic 17 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the logic 17 may be implemented on a semiconductor apparatus, which may include the one or more substrates 15, with the logic 17 coupled to the one or more substrates 15. In some embodiments, the logic 17 may be at least partly implemented in one or more of configurable logic and fixed-functionality hardware logic on semiconductor substrate(s) (e.g., silicon, sapphire, gallium-arsenide, etc.). For example, the logic 17 may include a transistor array and/or other integrated circuit components coupled to the substrate(s) 15 with transistor channel regions that are positioned within the substrate(s) 15. The interface between the logic 17 and the substrate(s) 15 may not be an abrupt junction. The logic 17 may also be considered to include an epitaxial layer that is grown on an initial wafer of the substrate(s) 15.

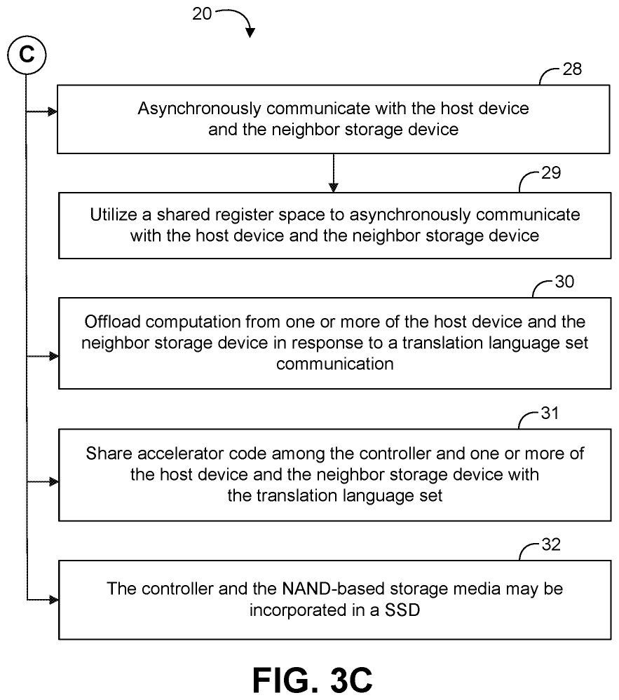

Turning now to FIGS. 3A to 3C, an embodiment of a method 20 of controlling storage may include controlling access to a NAND-based storage media with a controller at block 21, communicating with a host device and a neighbor storage device through a translation language set at block 22, converting the translation language set to native commands at block 23, and executing the native commands at block 24. For example, the method 20 may include notifying and receiving capability notifications to the host device and the neighbor storage device with the translation language set at block 25. Some embodiments of the method 20 may further include re-configuring one or more of the controller and the NAND-based storage media in response to a translation language set communication from one or more of the host device and the neighbor storage device at block 26. For example, the method 20 may also include locking a configuration of the controller and the NAND-based storage media in response to a translation language set communication from one or more of the host device and the neighbor storage device at block 27.

In some embodiments, the method 20 may further include asynchronously communicating with the host device and the neighbor storage device at block 28. For example, the method 20 may include utilizing a shared register space to asynchronously communicate with the host device and the neighbor storage device at block 29. Some embodiments of the method 20 may further include offloading computation from one or more of the host device and the neighbor storage device in response to a translation language set communication at block 30 (e.g., or offloading computation from the controller to the host device or the neighbor storage device), and/or sharing accelerator code among the controller and one or more of the host device and the neighbor storage device with the translation language set at block 31. In any of the embodiments herein, the controller and the NAND-based storage media may be incorporated in a SSD at block 32.

Embodiments of the method 20 may be implemented in a system, apparatus, computer, device, etc., for example, such as those described herein. More particularly, hardware implementations of the method 20 may include configurable logic such as, for example, PLAs, FPGAs, CPLDs, Course-Grained Reconfigurable Fabric (CGRA), or in fixed-functionality logic hardware using circuit technology such as, for example, ASIC, CMOS, or TTL technology, or any combination thereof. Alternatively, or additionally, the method 20 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 20 may be implemented on a computer readable medium as described in connection with Examples 28 to 36 below. Embodiments or portions of the method 20 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide technology for a SSD Hive Event Switch Transmission Asynchronous context (HIVES-TAC). Some embodiments may optionally utilize machine learning (ML), artificial intelligence (AI), and/or Machine Programming (MP) technology such as a deep neural network (DNN) as one possible technology that the host can utilize to determine how to re-assign/adapt SSD usage and upgrade/downgrade SSDs associated with the host. For example, a DNN may be trained to recognize optimizations that may benefit the infrastructure and automatically optimize drives based on the self, neighbors' and host's set of capabilities. Some embodiments may utilize Translation Language Set (TLS) communications for each SSD module to notify and receive Capability Notifications (CNs) to neighbor SSDs and/or the host within a virtual application/service. Each SSD module, computation module, and the host have their own translation tables. Via the TLS communications, embodiments of a host may be configured to automatically re-assign/adapt SSD usage and upgrade/downgrade SSDs accordingly. The host may use any suitable techniques (e.g., AI, ML, MP, etc.) to decide whether the host should re-assign/adapt SSD usage and/or upgrade/downgrade a particular SSD. For example, MP technology may emphasize advancements in the human-to-computer and computer-to-machine-learning interfaces. Some embodiments may emphasize the creation or refinement of algorithms or core hardware and software building blocks through ML, such as the use of ML-based constructs to autonomously evolve hardware and software

Conventionally, if a server's storage is composed of disjoint generations of SSDs, the topology of the storage may not be optimized based on the data cluster's set of goals. Addressing how the host assigns, upgrades/downgrades, adapts, stores, and loads to the SSD module may be problematic, particularly as the SSDs and or server storage changes over time. Advantageously, some embodiments provide technology for a feature that adds functionality and adaptability to provide a set of configurations based on the host's use cases and the connected topology on the system.

An embodiment of TLS technology allows for internal data structures to be dynamically translated into the native language set allowing for seamless translation as well as firmware context switching for disjoint executable firmware/software images and/or requests of assistance from sub-systems. TLS technology supports a modular data transfer model such that, when applied to a heterogeneous system, TLS may be utilized to communicate to a CPU, FPGA, GPU, NIC, etc. through a native command set. Advantageously, TLS may be leveraged to take advantage of the attributes of numerous interconnected modules such as faster process inference (CPU), training for a DNN (GPU), concurrent space search for a DNN (FPGA), module computation device offloading, etc.

For a smart SSD, some embodiments may share the accelerator code or reconfigure to support the host's goals for the given workload based on the historical feedback. For example, the host may give a secure data unpack and SQL acceleration request. In response to the request, other features will be disabled over time to further accelerate these accelerators on the reconfigurable space. In cases of high throughput computation, switching all resources over, assuming the reconfigurable space may be reclaimed, could increase throughput linearly to the additional slots reconfigured. For example, 10 additional reconfigurable slots may correspond to an increase of instructions per cycle from maybe 2 to 12, corresponding to a 10× throughput increase.

Some embodiments may advantageously provide technology to address how a host can automatically re-assign/adapt SSD usage, features, and upgrade/downgrade host-connected SSD modules accordingly. Some embodiments utilize a set of host goals to allow heterogenous modules to provide configurations, translation, and operation modes. Optimizations may be based on the SSD itself, neighbors of the SSD, and the host's set of capabilities. Each SSD module may use the historical, current, and future known capabilities to produce a set of configurations for the host and user to select. The selection then allows for a host to context switch according to a cloud service task. The service can enable hardware reconfiguration of internal processing to offload smart computation if a device cannot service the computation or, as a new device is shared, the reconfiguration streams can be shared increasing older device capabilities.

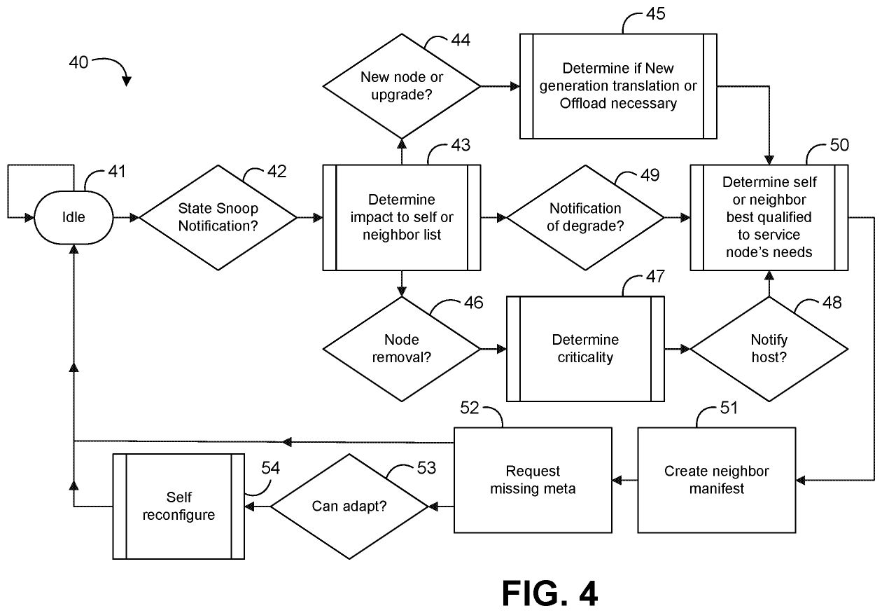

With reference to FIG. 4, an embodiment of a process flow 40 includes moving from idle at box 41 to determining if a state snoop notification is to be performed at box 42, which leads to determining an impact to self or a neighbor list at box 43. If there is a new node or upgrade at box 44, the process flow 40 may proceed to determining if there is a new generation translation or if offload is necessary at box 45. If node removal is needed at box 46, the process flow 40 may proceed to determine criticality at box 47 and determine if the host is to be notified at box 48. After box 45 or 48, or if there is a notification of a degrade at box 49, the process flow 40 may proceed to determining if self or a neighbor is best qualified to service a node's need at box 50, creating a neighbor manifest at box 51, and requesting missing meta information at box 52. After box 52, the process flow 40 may return to idle at box 41, or may determine if the self can adapt at box 53 and performing a self-reconfigure at box 54 before returning to idle at box 41.

The usage of the feature set will allow the host to enhance over time or repurpose existing systems to dynamically change with the usage model's needs. Embodiments of HIVES-TAC may improve the ability to integrate different generations of storage technology. Subsequent generations may enhance integration by maintaining compatibility of the full set of product features. Embodiments of HIVES-TAC may improve systematic and incremental updateability of heterogenous storage environments.

As new generations of SSDs are released, datacenter customers may benefit from technology that supports scalable and dynamic datacenters. The computational hardware in these datacenters are not always replaced holistically so there is a need for a flexible and adaptable technology. Embodiments advantageously addresses these challenges by adding host and controller features such as profiling, benchmarking, feature translations, etc. into heterogeneous systems. Embodiments of a featured model introduces a real-time intelligent cooperative usage model of modules in a heterogeneous storage environment. Advantageously, embodiments may allow generations to mutually adapt.

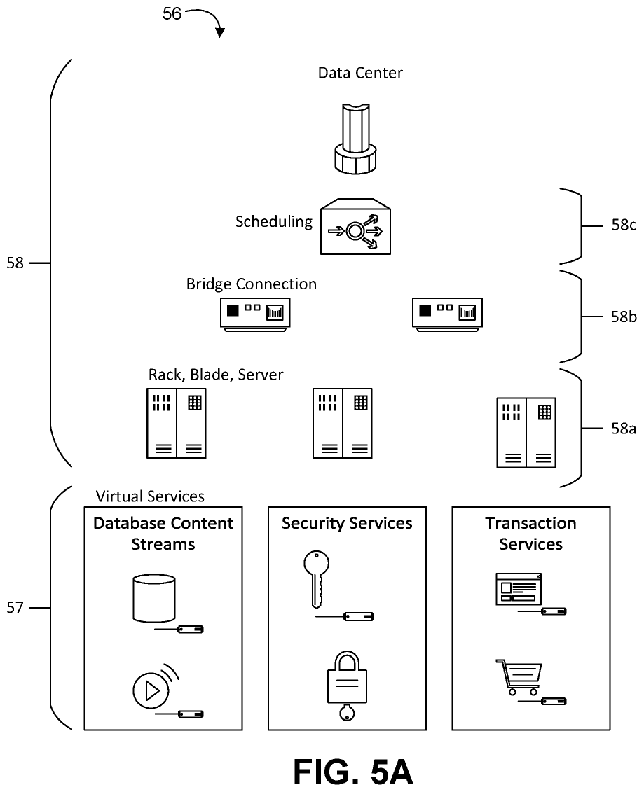

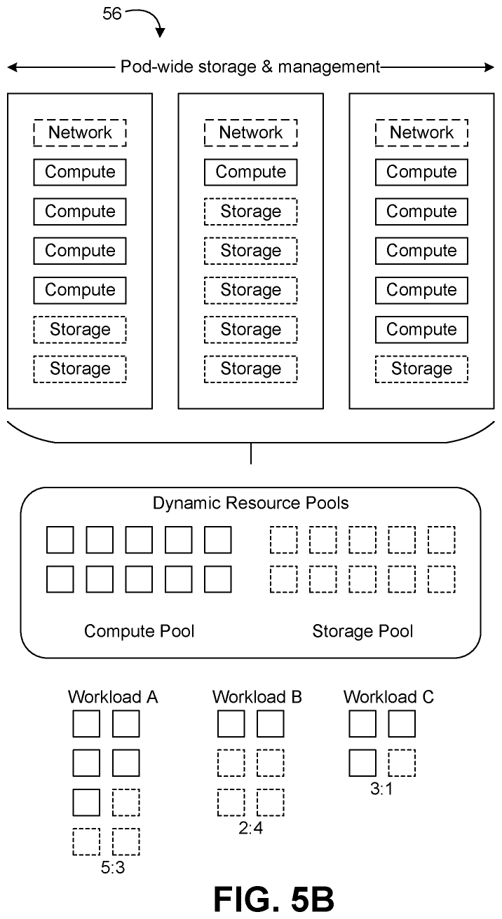

With reference to FIGS. 5A to 5B, an embodiment of a computing environment 56 may support of variety of virtual services 57 (e.g., database content streams, security services, transaction services, etc.) at a data center 58 which may include a plurality of computing devices 58a (racks, blades, servers, etc.) coupled via bridge connections 58b and scheduling hardware/software 58c. FIG. 5B shows an example of an allocation and partitioning of a storage resource based on an application.

Multi-level memory repurposing, sometimes also referred to as Just-in-Time Block Repurposing (JiTBR), provides technology to reprogram a memory block from a first number of bits to a second number of bits, typically to reduce loss of defective NAND erase blocks. As the density of NAND technology increases, longer latency may be encountered at the cost of high throughput. For example, a single level cell (SLC) may provide less capacity but faster throughput as compared to a multi-level cell (MLC), which may provide less capacity but faster throughput as compared to a tri-level cell (TLC), and so on. The choice of throughput or latency optimized operations, however, may be somewhat arbitrary because some NAND technology can natively support more than one programming mode (e.g., SLC, MLC, TLC, quad-level cell (QLC), and so on). For example, a particular namespace may benefit from some middle ground latency to throughput (e.g., latency in between the lowest possible latency and highest possible latency with a tradeoff of less capacity).

As a media module ages, the performance decreases. In conventional technologies, blocks with unsatisfactory performance may be disabled to maintain a desired storage performance requirement. With block repurposing, however, as a block ages the sensing of the module may be re-defined to interpret the energy signatures in lower modes of operation. The decreased level of sensing and charging of the module means that the performance of the block changes in respect to reads and programs. Identification of these modules for re-use allows for a minimization of spare loss for critical media events. The higher potential of these blocks means they may support construction of faster data streams which utilize the repurposed blocks. Accordingly, an SSD's capacity, performance and endurance can change over time.

Some embodiments provide technology to allow a host to recognize these changes in an SSD and repurpose the SSD (e.g., change the workload) with seamless meta-data translation. Utilizing meta-data transfer allows for seamless upgrade and downgrade in the event software executable images are not compatible.

As shown in FIG. 5A, the data center 58 can have several services within the compute cluster. In order to be dynamic, these services need to have the ability to translate between compute nodes. FIG. 5B shows, for a specific rack set, how the resource pool allows for system partitioning. Workload A shows 5 compute blades and 3 storage blades for the virtual service. For example, a storage blade may occupy one unit (1U) or two units (2U) of a rack. A 1U storage blade may support up to 8 NVMe SSDs, while a 2U storage blade may support up to 24 NVMe SSDs. This versatile platform addresses a wide variety of applications and workloads, but provides opportunity for the storage environment to become heterogeneous as the SSDs age, or are replaced or upgraded over time.

In accordance with some embodiments, each module (e.g., SSD) generation has a TLS, that is the feature table for sequential chained models/families A major generation may indicate significant algorithmic changes for table creation, whereas a minor generation may indicate a less significant extension to the current major generation. Each sequential (SSD) generation is configured to understand the last generation's feature set and convert to the latest common language. A chained TLS indicates that the latest generation unit can revert sequentially such that it can communicate with the oldest generation unit within the rack limiting the scope to the current server module state. In some embodiments, TLS may include a feature that allows the use of internal DNN accelerators for workloads that can be translated to directly convert the instance or partition a subset of an acceleration.

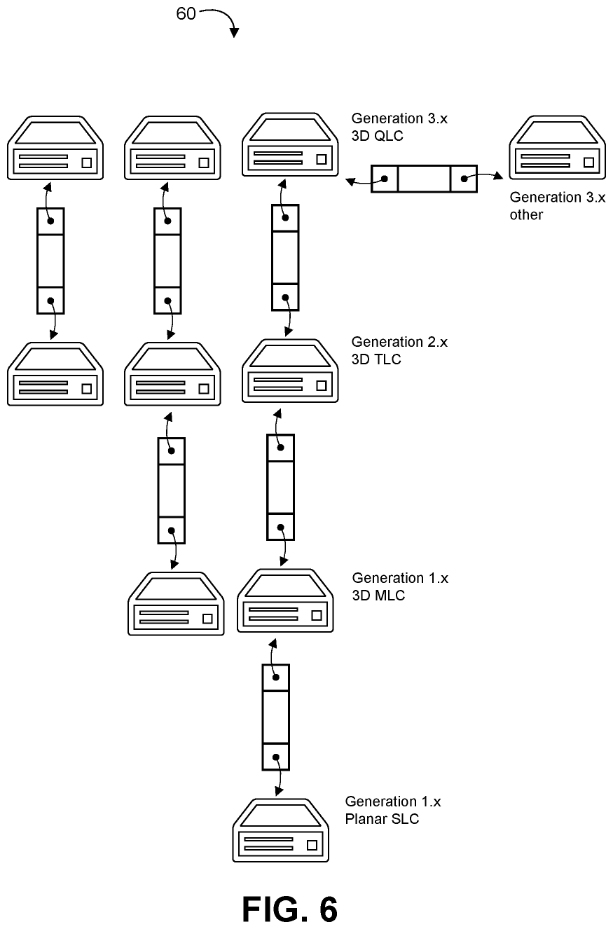

With reference to FIG. 6, an embodiment of storage system 60 includes a plurality of first generation, second generation, and third generation SSDs, with TLS communication paths between the product family and technology switches. For example, Generation 1.x of the SSDs may include planar SLC NAND media and/or 3D MLC NAND media. Generation 2.x of the SSDs may include 3D TLC NAND media. Generation 3.x of the SSDs may include 3D QLC NAND media, other advanced storage technologies, and/or other future storage technologies. Embodiments of this example TLS communication path may have each SSD module configured to notify and receive CNs to neighbors and/or the host within a virtual application/service. The CN service may use any suitable access technology, non-limiting examples of which include common internet file system (CIFS), server message block (SMB), NVMe over fabric (FC-NVMe), network file system (NFS), etc., to share a memory space. For performance critical services, the CN service is set to only notify the host at designated communication times. In some embodiments, the TLS communication is enabled by an administration command enabling the asynchronous notification on the protocol layer. The benefits of host arbitration in SSD communication is to strategically load the configuration based on the application. In services continuously executing on the same set, the benefit of neighbor communication is if an SSD is able to improve the computational path significantly then the SSD can context switch the neighbor.

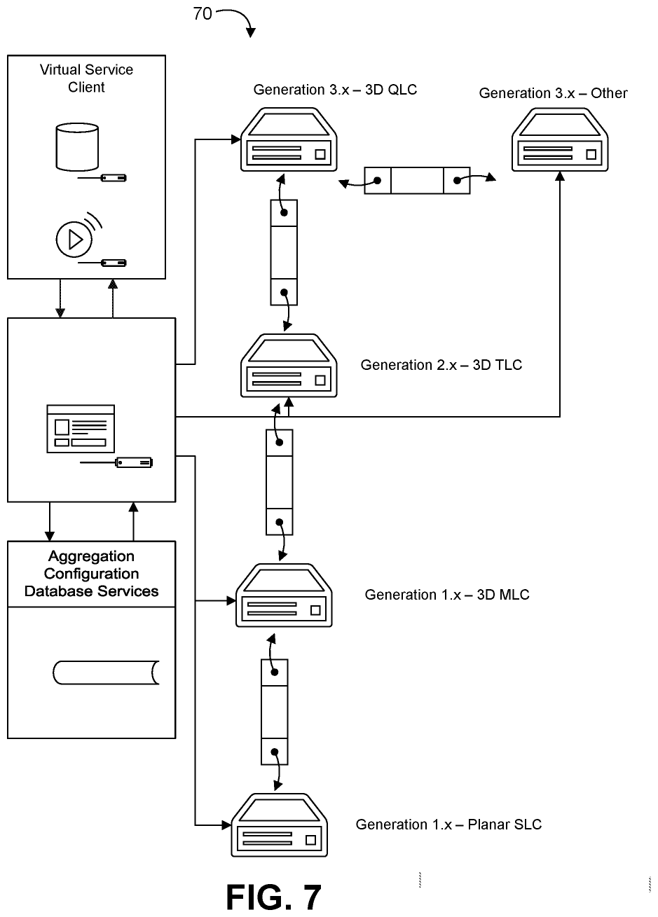

With reference to FIG. 7, an embodiment of storage system 70 includes a plurality of first generation, second generation, and third generation SSDs, with TLS communication paths between the product family and technology switches. FIG. 7 shows how various virtual services, AI arbitration services, and aggregation configuration database services may utilize a topology with a variety of SSD generations. To mitigate protocol noise on computational intense workloads, smart or optimized SSDs are configured to asynchronously notify the host of their respective states/capabilities/configurations. The configurator host then aggregates that information based on the goals of the service. In the case of non-optimized performance, the SSD notifies the host of a change request based on real-time performance projections for the workload. These abilities of aggregation and sub-optimized performance allow configuration hosts to work together in a swarm. The swarming can be achieved by the virtual service requesting bounded quality of service (QoS) and the storage server authority controlled by AI agents balancing the system based on known aggregated data.

As noted above, embodiments include technology to provide CNs between an SSD, neighbor SSDs, and/or a host. A binding CN indicates an amount of time to convert to a capability, a time to failure of a feature, a projected feature set, and relevant metadata. For each notification the host or neighbor can accept the request, deny the request, or sleep the protocol, awaiting the next request optionally, continuing to self-evaluate the performance of its current state.

When the host chooses a capability desired for a module, the CPU can lock or free the configuration to allow the module to continue at a set capability or allow the SSD to adapt based on in-bound requests. The host can communicate based on the desired traits then request a merge, separate, favor, dislike, or other unique request. The merge request would consist of marking a DNN snapshot desired from each configuration extracted and then merge the dependency chain with the optimized configuration, removing non-dependent chains. The outcome would be a more focused DNN pertaining to the marked traits. A separate operation may request to extract a DNN configuration related to the specific request. A favor may refer to change in the weight of the DNN configuration to add more weight to the DNN configuration chain and removing an un-necessary configuration for a focused learning target. Table 1 shows example controller modes of operation for data transferring.

TABLE 1

| | |
|---|---|
| Translation Language Set | Version number |
| (TLS) | (e.g., 3.0, 2.1, 2.0, etc.) |
| Capabilities Notification | Acknowledge, Reject, Sleep, Wake |
| (CN) | |
| Set Lock or Free Prediction | Item/pool to lock or free |
| (SL-FP) | |
| Feature or Path Hint/ | Merge, separate, favor, dislike, |
| Suggestion/Clue (FP-HSC) | unique (item or set) |
| Event Status | Healthy, exceeding expectations, |
| | critical, failure, dirty, recovery, etc. |

To allow host side configuration, each module can use a bit stream or buffer to allow for erase, load, and store configuration capabilities. With the host's ability to permit each system to be configured on the fly, the host can initiate a switch to change into a desired configuration state for in-bound workload requests. When the workload is executing, the host can ask for behavior to trend in a direction based on FP-HSC and grade the system performance to inform the AI subsystem and, in doing so, fast track the system along the desired path. In the event the host loses context of a particular SSD module, a query through telemetry is used to examine current capabilities, reducing the overhead storage required. The table/element events will allow a learned profile mode to be shared between modules enabling dynamic contexts for the application or usage case.

In order to allow host side configuration, each controller can allow a bit stream of the configuration allowing for wipe, load, and store capabilities. The table/element events will allow learned profile mode to be shared between modules enabling dynamic contexts for the application or usage case. With the host ability to allow each system to be configured on the fly, the host can initiate a switch to change into a desired configuration state for inbound workload requests. When the workload is executing, the host can ask for behavior to trend in a direction based on FP-HSC and grade the system to indicate the AI subsystem fast track the system towards a path. In the event the host loses context of a particular module, the host can view the set capabilities to allow a reduction in the overall memory footprint. Table 2 shows example host configuration modes of operation.

TABLE 2

| Mode | Operator |
|---|---|
| Table or Element | Erase, Load, Store |
| Notify | Switch |
| Ask | Desired capabilities |
| View | Active mode, Gen X.Y |
| Grade | Based on the host's set indicate |
| | the current preference level. |

When the drive moves to a failed state, the system will initiate a recovery mode where the system will use the historical or host-provided data to execute the modeled system, predict the capabilities, and test generated content. When test cases fail for modes, the system will use the new data to fine tune the model and repeat the process. When the prediction passes the tests generated, the system will halt the computational state and indicate a capability change.

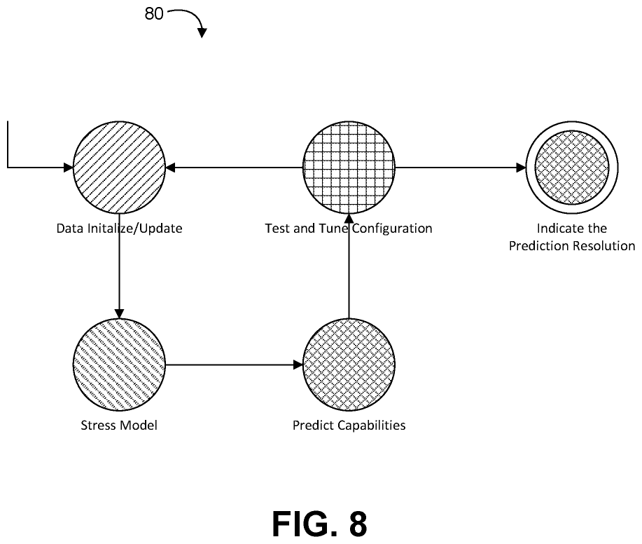

With reference to FIG. 8, an embodiment of a process flow 80 shows a high level application of AI, ML, MP, and Deep Learning for internal capabilities. An example application is for a datacenter customer to use the capabilities above to train, teach, and adapt data cluster(s) to a cloud user's needs over time. More particularly, as the technical team integrates the modules in the system, the software backbone implementation uses the characteristics of each system to tune the individual hardware cluster based on the use case. As the user or application maps to clustering systems, each of these hardware sets uses the interfaces and TLS to determine the unique optimized configuration.

Due to the dynamic nature of data cluster applications, a scheduler and known set of configurations (e.g., each targeting specific, modifiable parameters) would be used to make coarse adjustments, gauge efficiency-performance-power, and begin tuning to reach a local maxima on the desired traits. From there, fine adjustments are made over time. Configurations that perform particularly poorly in performance can be marked as “dirty” for the sub-system DNN, making them much less likely to be selected. The poor traits can be re-evaluated at idle times through telemetry extraction to evaluate and speculatively adjust to objectives based on offline computational techniques.

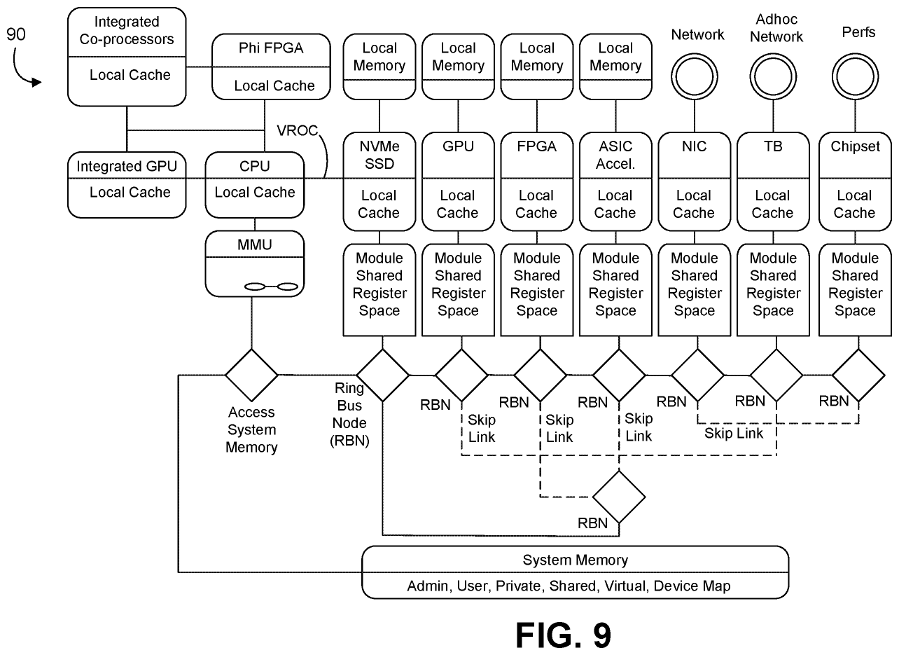

With reference to FIG. 9, an embodiment of a computing system 90 includes integrated co-processors, an integrated GPU, a CPU, a Phi FPGA, a MMU, one or more NVMe SSDs, all with local cache memory and interconnected as shown. The system 90 may further include additional modules such as a GPU, FPGA, ASIC accelerator, network interface card (NIC), thunderbolt (TB), and chipset interconnected as shown. The SSDs and the additional modules may all use a module shared register space connected through ring bus nodes (RBN) to each other, to the MMU, and to system memory. The data memory exchange connectivity for the system 90 supports TLS communication that extends to all the neighbor computational units. The TLS uses the module shared register space for the destination and source transfer between data transmissions. The internal transmission protocol utilizes a semaphore lock for requests from the source to the destination to initiate. To accelerate the overhead, the max and least common multiple (LCM) allocate granularity for the memory region is embedded within the request. The request size set allows for the source and destination transfer to be possible even if the desired space is not possible. The significance of the LCM is that if a partial set is allocable then the transmission can be conducted in a burst of smaller sets. For the case of no space, a response is held off for a timeframe of bus beats.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

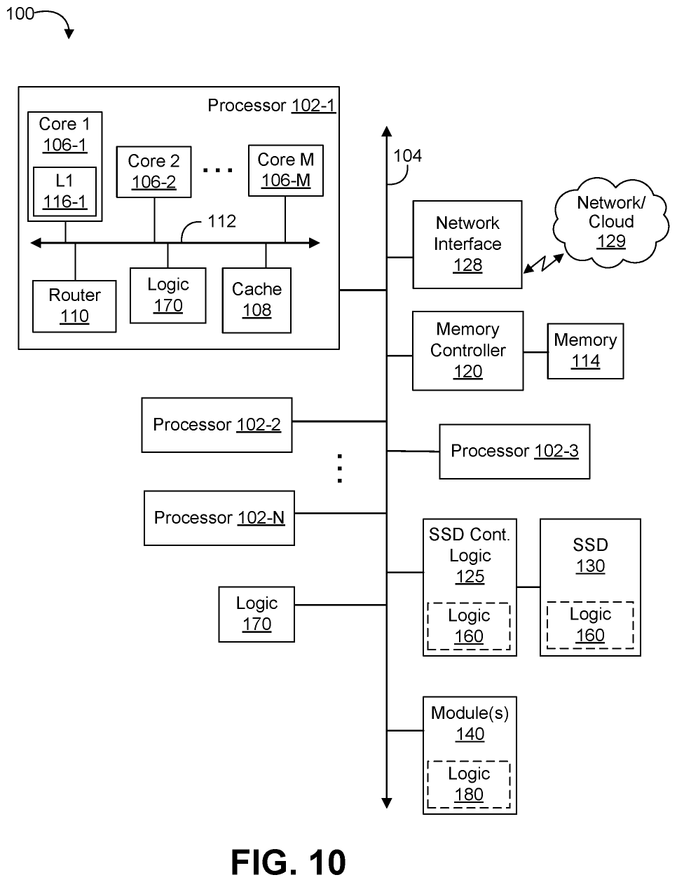

Turning now to FIG. 10, an embodiment of a computing system 100 may include one or more processors 102-1 through 102-N (generally referred to herein as “processors 102” or “processor 102”). The processors 102 may communicate via an interconnection or bus 104. Each processor 102 may include various components some of which are only discussed with reference to processor 102-1 for clarity. Accordingly, each of the remaining processors 102-2 through 102-N may include the same or similar components discussed with reference to the processor 102-1.

In some embodiments, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 170, memory controllers, or other components.

In some embodiments, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that is utilized by one or more components of the processor 102-1, such as the cores 106. For example, the cache 108 may locally cache data stored in a memory 114 for faster access by the components of the processor 102. As shown in FIG. 10, the memory 114 may be in communication with the processors 102 via the interconnection 104. In some embodiments, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 10, memory 114 may be coupled to other components of system 100 through a memory controller 120. Memory 114 may include volatile memory and may be interchangeably referred to as main memory or system memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

The system 100 may communicate with other devices/systems/networks via a network interface 128 (e.g., which is in communication with a computer network and/or the cloud 129 via a wired or wireless interface). For example, the network interface 128 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 129.

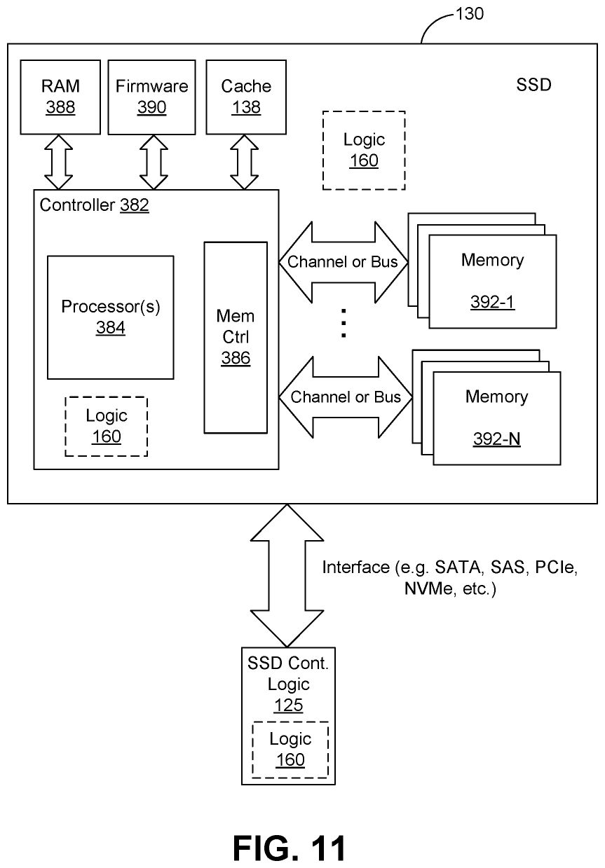

The system 100 may include one or more modules 140 coupled to the interconnect 104. Non-limiting examples of the modules 140 include neighbor SSDs, a GPU, a NIC, an accelerator, etc. System 100 may also include a storage device such as a SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 10, logic 125 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), etc.) with one or more other components of system 100 (for example where the storage bus is coupled to interconnect 104 via some other logic like a bus bridge, chipset, etc.) Additionally, logic 125 may be incorporated into memory controller logic (such as those discussed with reference to FIG. 11) or provided on a same integrated circuit (IC) device in various embodiments (e.g., on the same circuit board device as the SSD 130 or in the same enclosure as the SSD 130).

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein), including the cores 106, interconnections 104 or 112, components outside of the processor 102, SSD 130, SSD bus, SATA bus, logic 125, logic 160, logic 170, logic 180, etc., to sense variations in various factors affecting power/thermal behavior of the system/platform, such as temperature, operating frequency, operating voltage, power consumption, and/or inter-core communication activity, etc.

FIG. 11 illustrates a block diagram of various components of the SSD 130, according to an embodiment. As illustrated in FIG. 11, logic 160 may be located in various locations such as inside the SSD 130 or controller 382, etc., and may include similar technology as discussed in connection with FIG. 10. The SSD 130 includes a controller 382 (which in turn includes one or more processor cores or processors 384 and memory controller logic 386), cache 138, RAM 388, firmware storage 390, and one or more memory devices 392-1 to 392-N (collectively memory 392, which may include NAND media, or other types of non-volatile memory). The memory 392 is coupled to the memory controller logic 386 via one or more memory channels or busses. Also, SSD 130 communicates with logic 125 via an interface (such as a SATA, SAS, PCIe, NVMe, etc., interface). Processors 384 and/or controller 382 may compress/decompress data written to or read from memory devices 392-1 to 392-N.

As illustrated in FIGS. 10 and 11, the SSD 130 may include logic 160, which may be in the same enclosure as the SSD 130 and/or fully integrated on a printed circuit board (PCB) of the SSD 130. The system 100 may include further logic 170 outside of the SSD 130, and logic 180 in the modules 140. One or more of the features/aspects/operations discussed with reference to FIGS. 1-9 may be performed by one or more of the components of FIGS. 10 and/or 11. Also, one or more of the features/aspects/operations of FIGS. 1-9 may be programmed into the firmware 390. Further, SSD controller logic 125 may also include logic 160. Advantageously, the logic 160, logic 170, and/or logic 180 may include technology to implement one or more aspects of the system 10 (FIG. 1), the apparatus 14 (FIG. 2), the method 20 (FIGS. 3A to 3C), the process flow 40 (FIG. 4), the computing environment 56 (FIGS. 5A to 5B), the storage system 60 (FIG. 6), the storage system 70 (FIG. 7), the process flow 80 (FIG. 8), the computing system 90 (FIG. 9), and/or any of the features discussed herein. For example, the logic 170 may include technology to implement the host device/computer system/agent aspects of the various embodiments described herein while the logic 160 may include technology to implement the storage device aspects of the various embodiments described herein. The logic 180 in the modules 140 may be similarly configured to provide TLS features as described herein for the modules 140.

In particular, the logic 160 may be configured to communicate with the processor(s) 102 and the module(s) 140 through a TLS, convert the TLS to native commands, and execute the native commands. For example, the logic 160 may be configured to notify and receive CNs to the processor(s) 102 and the module(s) 140 with the TLS. In some embodiments, the logic 160 may be further configured to re-configure one or more of the SSD controller logic 125, the memory controller logic 386, and the memory 392 in response to a TLS communication from one or more of the processor(s) 102 and the module(s) 140. For example, the logic 160 may also be configured to lock a configuration of the SSD controller logic 125, the memory controller logic 386, and the memory 392 in response to a TLS communication from one or more of the processor(s) 102 and the module(s) 140.

In some embodiments, the logic 160 may be further configured to asynchronously communicate with the processor(s) 102 and the module(s) 140. For example, the logic 160 may be configured to utilize a module shared register space to asynchronously communicate with the processor(s) 102 and the module(s) 140. In some embodiments, the logic 160 may be further configured to offload computation from one or more of the processor(s) 102 and the module(s) 140 in response to a TLS communication (e.g., or from the SSD 130 to the processor(s) 102 or the module(s) 140, and/or to share accelerator code among the SSD 130 and one or more of the processor(s) 102 and the module(s) 140 with the TLS.

In other embodiments, the SSD 130 may be replaced with any suitable storage/memory technology/media. In some embodiments, the logic 160/170/180 may be coupled to one or more substrates (e.g., silicon, sapphire, gallium arsenide, printed circuit board (PCB), etc.), and may include transistor channel regions that are positioned within the one or more substrates. In other embodiments, the SSD 130 may include two or more types of storage media. For example, the bulk of the storage may be NAND and may further include some faster, smaller granularity accessible (e.g., byte-addressable) NVM. The SSD 130 may alternatively, or additionally, include persistent volatile memory (e.g., battery or capacitor backed-up DRAM or SRAM). For example, the SSD 130 may include POWER LOSS IMMINENT (PLI) technology with energy storing capacitors. The energy storing capacitors may provide enough energy (power) to complete any commands in progress and to make sure that any data in the DRAMs/SRAMs is committed to the non-volatile NAND media. The capacitors may act as backup batteries for the persistent volatile memory. As shown in FIGS. 10 and 11, features or aspects of the logic 160, the logic 170, and/or the logic 180 may be distributed throughout the system 100, and/or co-located/integrated with various components of the system 100.

### Additional Notes and Examples

Example 1 includes an electronic apparatus, comprising one or more substrates, and a controller coupled to the one or more substrates, the controller including logic to control access to a persistent storage media, communicate with a host device and a neighbor storage device through a translation language set, convert the translation language set to native commands, and execute the native commands.

Example 2 includes the apparatus of Example 1, wherein the logic is further to notify and receive capability notifications to the host device and the neighbor storage device with the translation language set.

Example 3 includes the apparatus of any of Examples 1 to 2, wherein the logic is further to re-configure one or more of the controller and the persistent storage media in response to a translation language set communication from one or more of the host device and the neighbor storage device.

Example 4 includes the apparatus of Example 3, wherein the logic is further to lock a configuration of the controller and the persistent storage media in response to a translation language set communication from one or more of the host device and the neighbor storage device.

Example 5 includes the apparatus of any of Examples 1 to 4, wherein the logic is further to asynchronously communicate with the host device and the neighbor storage device.

Example 6 includes the apparatus of Example 5, wherein the logic is further to utilize a shared register space to asynchronously communicate with the host device and the neighbor storage device.

Example 7 includes the apparatus of any of Examples 1 to 6, wherein the logic is further to offload computation from one or more of the host device and the neighbor storage device in response to a translation language set communication.

Example 8. The apparatus of any of Examples 1 to 7, wherein the logic is further to share accelerator code among the controller and one or more of the host device and the neighbor storage device with the translation language set.

Example 9 includes the apparatus of any of Examples 1 to 8, wherein the controller and the persistent storage media are incorporated in a solid-state drive.

Example 10 includes an electronic storage system, comprising persistent storage media, and a controller communicatively coupled to the persistent storage media, the controller including logic to communicate with a host device and a neighbor storage device through a translation language set, convert the translation language set to native commands, and execute the native commands.

Example 11 includes the system of Example 10, wherein the logic is further to notify and receive capability notifications to the host device and the neighbor storage device with the translation language set.

Example 12 includes the system of any of Examples 10 to 11, wherein the logic is further to re-configure one or more of the controller and the persistent storage media in response to a translation language set communication from one or more of the host device and the neighbor storage device.

Example 13 includes the system of Example 12, wherein the logic is further to lock a configuration of the controller and the persistent storage media in response to a translation language set communication from one or more of the host device and the neighbor storage device.

Example 14 includes the system of any of Examples 10 to 13, wherein the logic is further to asynchronously communicate with the host device and the neighbor storage device.

Example 15 includes the system of Example 14, wherein the logic is further to utilize a shared register space to asynchronously communicate with the host device and the neighbor storage device.

Example 16 includes the system of any of Examples 10 to 15, wherein the logic is further to offload computation from one or more of the host device and the neighbor storage device in response to a translation language set communication.

Example 17. The system of any of Examples 10 to 16, wherein the logic is further to share accelerator code among the controller and one or more of the host device and the neighbor storage device with the translation language set.

Example 18 includes the system of any of Examples 10 to 17, wherein the controller and the persistent storage media are incorporated in a solid-state drive.

Example 19 includes a method of controlling storage, comprising controlling access to a persistent storage media with a controller, communicating with a host device and a neighbor storage device through a translation language set, converting the translation language set to native commands, and executing the native commands.

Example 20 includes the method of Example 19, further comprising notifying and receiving capability notifications to the host device and the neighbor storage device with the translation language set.

Example 21 includes the method of any of Examples 19 to 20, further comprising re-configuring one or more of the controller and the persistent storage media in response to a translation language set communication from one or more of the host device and the neighbor storage device.

Example 22 includes the method of Example 21, further comprising locking a configuration of the controller and the persistent storage media in response to a translation language set communication from one or more of the host device and the neighbor storage device.

Example 23 includes the method of any of Examples 19 to 22, further comprising asynchronously communicating with the host device and the neighbor storage device.

Example 24 includes the method of Example 23, further comprising utilizing a shared register space to asynchronously communicate with the host device and the neighbor storage device.

Example 25 includes the method of any of Examples 19 to 24, further comprising offloading computation from one or more of the host device and the neighbor storage device in response to a translation language set communication.

Example 26 includes the method of any of Examples 19 to 25, further comprising sharing accelerator code among the controller and one or more of the host device and the neighbor storage device with the translation language set.

Example 27 includes the method of any of Examples 19 to 26, wherein the controller and the persistent storage media are incorporated in a solid-state drive.

Example 28 includes at least one non-transitory machine readable medium comprising a plurality of instructions that, in response to being executed on a computing device, cause the computing device to control access to a persistent storage media with a controller, communicate with a host device and a neighbor storage device through a translation language set, convert the translation language set to native commands, and execute the native commands.

Example 29 includes the at least one non-transitory machine readable medium of Example 28, comprising a plurality of further instructions that, in response to being executed on the computing device, cause the computing device to notify and receive capability notifications to the host device and the neighbor storage device with the translation language set.

Example 30 includes the at least one non-transitory machine readable medium of any of Examples 28 to 29, comprising a plurality of further instructions that, in response to being executed on the computing device, cause the computing device to re-configure one or more of the controller and the persistent storage media in response to a translation language set communication from one or more of the host device and the neighbor storage device.

Example 31 includes the at least one non-transitory machine readable medium of Example 30, comprising a plurality of further instructions that, in response to being executed on the computing device, cause the computing device to lock a configuration of the controller and the persistent storage media in response to a translation language set communication from one or more of the host device and the neighbor storage device.

Example 32 includes the at least one non-transitory machine readable medium of any of Examples 28 to 31, comprising a plurality of further instructions that, in response to being executed on the computing device, cause the computing device to asynchronously communicate with the host device and the neighbor storage device.

Example 33 includes the at least one non-transitory machine readable medium of Example 32, comprising a plurality of further instructions that, in response to being executed on the computing device, cause the computing device to utilize a shared register space to asynchronously communicate with the host device and the neighbor storage device.

Example 34 includes the at least one non-transitory machine readable medium of any of Examples 28 to 33, comprising a plurality of further instructions that, in response to being executed on the computing device, cause the computing device to offload computation from one or more of the host device and the neighbor storage device in response to a translation language set communication.

Example 35 includes the at least one non-transitory machine readable medium of any of Examples 28 to 34, comprising a plurality of further instructions that, in response to being executed on the computing device, cause the computing device to share accelerator code among the controller and one or more of the host device and the neighbor storage device with the translation language set.

Example 36 includes the at least one non-transitory machine readable medium of any of Examples 28 to 35, wherein the controller and the persistent storage media are incorporated in a solid-state drive.

Example 37 includes a storage controller apparatus, comprising means for controlling access to a persistent storage media with a controller, means for communicating with a host device and a neighbor storage device through a translation language set, means for converting the translation language set to native commands, and means for executing the native commands.

Example 38 includes the apparatus of Example 37, further comprising means for notifying and receiving capability notifications to the host device and the neighbor storage device with the translation language set.

Example 39 includes the apparatus of any of Examples 37 to 38, further comprising means for re-configuring one or more of the controller and the persistent storage media in response to a translation language set communication from one or more of the host device and the neighbor storage device.

Example 40 includes the apparatus of Example 39, further comprising means for locking a configuration of the controller and the persistent storage media in response to a translation language set communication from one or more of the host device and the neighbor storage device.

Example 41 includes the apparatus of any of Examples 37 to 40, further comprising means for asynchronously communicating with the host device and the neighbor storage device.

Example 42 includes the apparatus of Example 41, further comprising means for utilizing a shared register space to asynchronously communicate with the host device and the neighbor storage device.

Example 43 includes the apparatus of any of Examples 37 to 42, further comprising means for offloading computation from one or more of the host device and the neighbor storage device in response to a translation language set communication.

Example 44. The apparatus of any of Examples 37 to 43, further comprising means for sharing accelerator code among the controller and one or more of the host device and the neighbor storage device with the translation language set.

Example 45 includes the apparatus of any of Examples 37 to 44, wherein the controller and the persistent storage media are incorporated in a solid-state drive.

Example 46 includes any of Examples 1 to 45, wherein the persistent storage media comprises NAND-based media.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An electronic apparatus, comprising:
one or more substrates; and
a controller coupled to the one or more substrates, the controller including logic to:
control access to a NAND-based storage media,
communicate with a host device and a neighbor storage device through a translation language set,
convert the translation language set to native commands, and
execute the native commands.

2. The apparatus of claim 1, wherein the logic is further to:
notify and receive capability notifications to the host device and the neighbor storage device with the translation language set.

3. The apparatus of claim 1, wherein the logic is further to:
re-configure one or more of the controller and the NAND-based storage media in response to a translation language set communication from one or more of the host device and the neighbor storage device.

4. The apparatus of claim 3, wherein the logic is further to:
lock a configuration of the controller and the NAND-based storage media in response to a translation language set communication from one or more of the host device and the neighbor storage device.

5. The apparatus of claim 1, wherein the logic is further to:
asynchronously communicate with the host device and the neighbor storage device.

6. The apparatus of claim 5, wherein the logic is further to:
utilize a shared register space to asynchronously communicate with the host device and the neighbor storage device.

7. The apparatus of claim 1, wherein the logic is further to:
offload computation from one or more of the host device and the neighbor storage device in response to a translation language set communication.

8. An electronic storage system, comprising:
NAND-based storage media; and
a controller communicatively coupled to the NAND-based storage media, the controller including logic to:
communicate with a host device and a neighbor storage device through a translation language set,
convert the translation language set to native commands, and
execute the native commands.

9. The system of claim 8, wherein the logic is further to:
notify and receive capability notifications to the host device and the neighbor storage device with the translation language set.

10. The system of claim 8, wherein the logic is further to:
re-configure one or more of the controller and the NAND-based storage media in response to a translation language set communication from one or more of the host device and the neighbor storage device.

11. The system of claim 10, wherein the logic is further to:
lock a configuration of the controller and the NAND-based storage media in response to a translation language set communication from one or more of the host device and the neighbor storage device.

12. The system of claim 8, wherein the logic is further to:
asynchronously communicate with the host device and the neighbor storage device.

13. The system of claim 12, wherein the logic is further to:
utilize a shared register space to asynchronously communicate with the host device and the neighbor storage device.

14. The system of claim 8, wherein the controller and the NAND-based storage media are incorporated in a solid-state drive.

15. A method of controlling storage, comprising:
controlling access to a NAND-based storage media with a controller;
communicating with a host device and a neighbor storage device through a translation language set;
converting the translation language set to native commands; and
executing the native commands.

16. The method of claim 15, further comprising:
notifying and receiving capability notifications to the host device and the neighbor storage device with the translation language set.

17. The method of claim 15, further comprising:
re-configuring one or more of the controller and the NAND-based storage media in response to a translation language set communication from one or more of the host device and the neighbor storage device.

18. The method of claim 17, further comprising:
locking a configuration of the controller and the NAND-based storage media in response to a translation language set communication from one or more of the host device and the neighbor storage device.

19. The method of claim 15, further comprising:
utilizing a shared register space to asynchronously communicate with the host device and the neighbor storage device.

20. The method of claim 15, further comprising:
sharing accelerator code among the controller and one or more of the host device and the neighbor storage device with the translation language set.
